(19) United States
(12) Patent Application Publication
(10) Pub. No.: US 2007/0192247 A1
(43) Pub. Date: Aug. 16, 2007

(54) Method and apparatus for implementing an activity watch for financial accounts

(76) Inventor: Lawrence L. West, Bonita, CA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/346,090

(22) Filed: Feb. 1, 2006

(51) Int. Cl. G06Q 40/00

(52) U.S. Cl. 705/42

(57) ABSTRACT

One embodiment of the present invention provides a system that facilitates an “activity watch” operation on a financial account. During operation, the system receives records for transactions associated with the financial account. These records are received at a third-party server from a financial institution which maintains the financial account, wherein the third-party server is independent from the financial institution. Next, the system applies one or more rules to the records to determine whether an alert should be triggered. If a rule indicates that an alert should be triggered, the system sends the alert to a user who has an interest in the financial account.

### BACKGROUND

### Related Art

The present invention relates to computer-based systems for maintaining financial information. More specifically, the present invention relates to a method and an apparatus for implementing an “activity watch” that monitors financial accounts, such as bank accounts and/or credit card accounts.

Financial institutions are presently using Internet technology to allow their customers to access account information online. This new capability enables customers to obtain up-to-date information about account transactions. However, customers typically do not have to time to continually monitor account transactions. Consequently, customers may not be aware of looming problems that can arise with their accounts. For example, a credit card account may be about to exceed a credit limit, or bank account balance may be nearly depleted making an overdraft likely. Even more importantly, there may be an identity theft problem, wherein a criminal is making fraudulent charges on a customer's credit card account.

### SUMMARY

One embodiment of the present invention provides a system that facilitates an “activity watch” operation on a financial account. During operation, the system receives records for transactions associated with the financial account. These records are received at a third-party server from a financial institution which maintains the financial account, wherein the third-party server is independent from the financial institution. Next, the system applies one or more rules to the records to determine whether an alert should be triggered. If a rule indicates that an alert should be triggered, the system sends the alert to a user who has an interest in the financial account.

In a variation on this embodiment, sending the alert to the user involves: sending an email to the user; sending a pager notification to the user; sending a recorded telephone message to the user; sending a facsimile to the user; or causing a human operator to contact the user.

In a variation on this embodiment, sending the alert to the user involves sending an escalating series of alerts to the user if the user does not respond to any of the alerts.

In a further variation, while sending the escalating series of alerts, the system first sends a low-level alert in the form of an email message. If the user does not respond to the low-level alert, the system sends a medium-level alert in the form of a pager notification or a recorded telephone message to the user. If the user does not respond to the medium-level alert, the system sends a high-level alert to the user by causing a human operator to telephone the user.

In a variation on this embodiment, after sending the alert, the system allows the user to login to the third party server to obtain details about the one or more transactions that triggered the alert.

In a variation on this embodiment, while receiving the records for the transactions, the system obtains account-access information from the user. The system uses this account-access information to obtain the records for the transactions associated with the financial account from the financial institution.

In a variation on this embodiment, the system allows the user to specify and/or modify the one or more rules that determine whether an alert should be triggered.

In a variation on this embodiment, the system uses feedback about whether alerts are false positive alerts, true positive alerts, false negative alerts or true negative alerts, to update the one or more rules that determine whether an alert should be triggered.

In a variation on this embodiment, the system uses an expert system (or neural network or other adaptive system) to adjust the one or more rules that determine whether an alert should be triggered based upon transaction history information associated with the user and/or similar users.

In a variation on this embodiment, while receiving the records for the transactions, the system receives records for multiple financial accounts belonging to the user, wherein the multiple financial accounts are associated with multiple financial institutions.

In a variation on this embodiment, the financial account can include: a bank account, a credit-card account, or a credit report for the user.

### BRIEF DESCRIPTION OF THE FIGURES

FIG. 1 illustrates an “activity watch server” in accordance with an embodiment of the present invention.

FIG. 2 illustrates the internal structure of the activity watch server in accordance with an embodiment of the present invention.

FIG. 3 presents a flow chart illustrating the process of configuring the activity watch server to monitor a user's account in accordance with an embodiment of the present invention.

FIG. 4 presents a flow chart illustrating how the activity watch server monitors the user's account in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices, such as disk drives, magnetic tape, CDs (compact discs), DVDs (digital versatile discs or digital video discs), or any device capable of storing data usable by a computer system.

Activity Watch Server

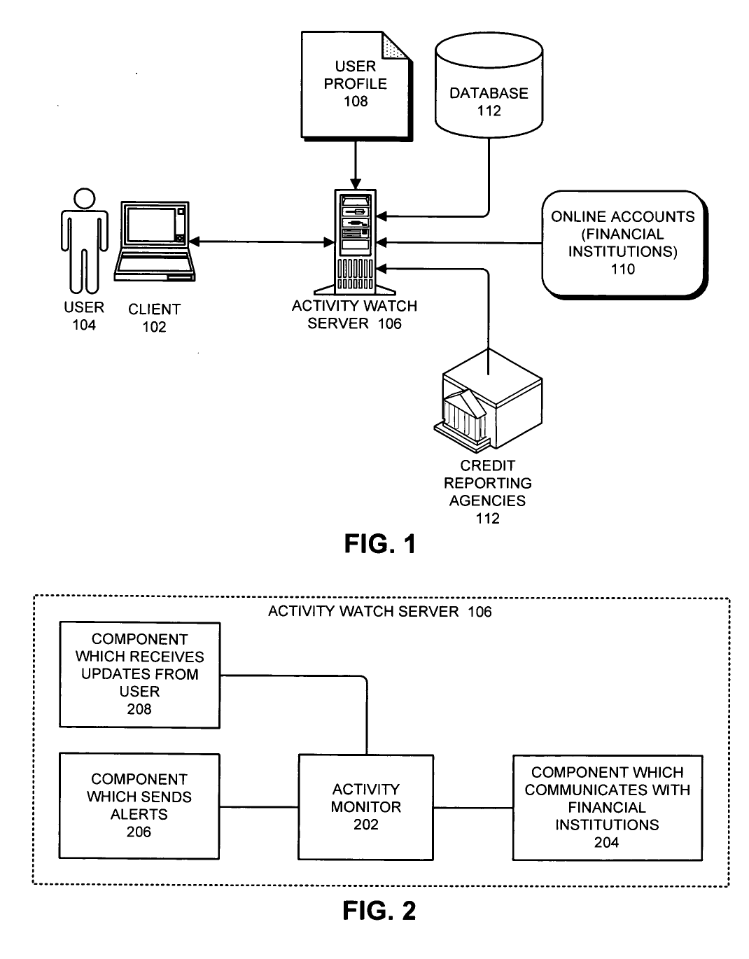

FIG. 1 illustrates an “activity watch server” 106 in accordance with an embodiment of the present invention. Activity watch server 106 can generally include any computational node (or a collection of distributed nodes providing services as one entity) including a mechanism for servicing requests from a client for computational and/or data storage resources. Activity-watch server 106 is associated with a local database 112, which stores transaction information associated with accounts for various users.

In FIG. 1, a user 104 interacts with activity-watch server 106 through a client system 102. Client system 102 can generally include any node on a network including computational capability and including a mechanism for communicating across the network.

Activity-watch server 106 constructs a “user profile” 108 based upon information obtained from user 104. The structure user profile 108 is described in more detail below in following sections of this specification.

Activity watch server 106 receives information about online accounts 10 from remote computer systems belonging to one or more financial institutions. Activity watch server 106 can also receive information from credit reporting agencies 12.

FIG. 2 illustrates the internal structure of activity-watch server 106 in accordance with an embodiment of the present invention. Activity-watch server 106 includes an activity monitor 202, which monitors account activity, either through polling or some other mechanism. Activity-watch server also includes a number of components, including: a component 208 which receives updates from users; a component 206 which sends alerts to the users; and a component 204 which communicates with financial institutions to obtain account information. The operations performed by these components are described in more detail below.

Configuring the Activity Watch Server

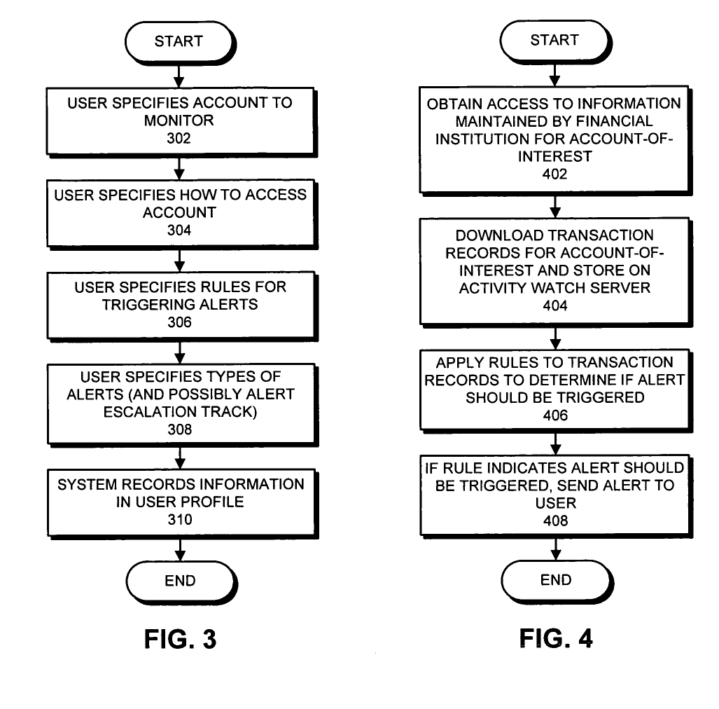

FIG. 3 presents a flow chart illustrating the process of configuring activity watch server 106 to monitor a user's account in accordance with an embodiment of the present invention. First, the user 104 specifies which accounts to monitor (step 302). Next, user 104 specifies how to access the accounts (step 304). User 104 also specifies rules for generating alerts (step 306), as well as the types of alerts to generate (step 308). The system then records this user-specified information in user profile 108 (step 310).

Monitoring a User's Account

FIG. 4 presents a flow chart illustrating how activity watch server 106 monitors an account in accordance with an embodiment of the present invention. First, the system obtains access to account information for one or more accounts-of-interest maintained by one or more financial institutions (step 402). For example, this can involve using a password from user profile 108 (which was previously supplied by user 104) to login to the account. Note that these accounts can include any type of account that can be accessed electronically, and for which it is possible to obtain itemized transaction information on a timely basis, preferably within a day or two. For example, these accounts can include bank accounts, credit card accounts, eBay accounts, and PayPal accounts. In addition to these types of accounts, user can also provide information needed to do credit checks. (Note that this may require some negotiation with the credit reporting agencies to ensure that that the account monitoring process does not affect the user's credit rating.)

Next, the system downloads transaction records for the accounts-of-interest and then stores these transaction records in database 112 within activity-watch server 106 (step 404). Note that users arrange to have their account data automatically uploaded to a secure third-party server on a regular basis, such as daily or weekly.

The system then applies rules to the transaction records to determine if an alert should be triggered (step 406). For example, these rules can be specified in the following form.
1. on a charge over $100 from a (new or distant) business generate a low-level alert;
2. on a charge exceeding $300 from a known business generate a low-level alert;
3. on an ATM withdrawal exceeding $100 generate a medium-level alert;
4. on an ATM withdrawal exceeding $300 generate a high-level alert; and
5. on total ATM withdrawals that exceed $400 during a 3-day period generate a high-level alert.

The user can also specify how the alerts are to be sent. For example, sending the alerts can involve: sending an email to the user; sending a pager notification to the user; sending a recorded telephone message to the user; sending a facsimile to the user; or causing a human operator to contact the user.

Finally, if a rule indicates that an alert should be triggered, the system sends the alert (or an escalating series of alerts) to the user (step 408). Note that an escalating series of alerts can be delivered through different communication mechanisms, which are configurable by the user. For example, the alerts can be delivered in a progression as follows:
1. a low-level alert would generate an email message;
2. a medium-level alert would generate an email message and a single automated phone call (to each phone number assigned for this purpose); and
3. a high-level alert would generate the medium alert response, plus a follow-up every four hours (phone calls during designated times, of course), and if no response is received within a day or so, a human phone call.
   A user can respond by punching-in a secret code to acknowledge the alert, or can respond by visiting a webpage to acknowledge an alert. (Obviously, accepting acknowledgements via email would be somewhat insecure using current Internet email systems).

One embodiment of the present invention also assists the user in dealing with identity theft problems when they arise: by contacting credit card companies, banks, credit reporting agencies, the police and/or the Department of Motor Vehicles (DMV).

One embodiment of the present invention maintains statistics on the rules specified by users, a well as various statistics about the users, such as the users' residence location, age, gender, income level and transaction history. These statistics can be incorporated into a more sophisticated model incorporating some type of “expert system” technology, such as neural networks, Bayesian filters or other adaptive techniques, to enable the system to better recognize identity theft. Note that these techniques can also facilitate other types of services, such as tax-related assistance.

The present invention can also be applied to provide balance protection (for example, through automatic transfers without the steep bank fees) or more sophisticated financial analyses (“you would save $100/month by refinancing”, etc.) to help users avoid looming problems.

In one embodiment of the present invention, the account information retrieved by the third-party server can be used for purposes in addition to generating alerts, such as backup and recovery of the data or remote access to the data.

In one embodiment of the present invention, the system uses feedback about whether alerts are false positive alerts, true positive alerts, false negative alerts or true negative alerts, to update the one or more rules that determine whether an alert should be triggered. Note that true negative alerts (fraudulent transactions that went undetected) would have to be determined manually after an identity theft has been reported.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for performing an activity watch operation on a financial account, comprising:
receiving records for transactions associated with the financial account;
wherein the records are received at a third-party server from a financial institution which maintains the financial account, wherein the third-party server is independent from the financial institution;
applying one or more rules to the records to determine whether an alert should be triggered; and
if a rule indicates that an alert should be triggered, sending the alert to a user who has an interest in the financial account.

2. The method of claim 1, wherein sending the alert to the user involves:
sending an email to the user;
sending a pager notification to the user;
sending a recorded telephone message to the user;
sending a facsimile to the user; or
causing a human operator to contact the user.

3. The method of claim 1, wherein sending the alert to the user involves sending an escalating series of alerts to the user if the user does not respond to any of the alerts.

4. The method of claim 1, wherein sending the escalating series of alerts involves:
sending a low-level alert in the form of an email message; and
if the user does not respond to the low-level alert, sending a medium-level alert in the form of a pager notification or a recorded telephone message to the user; and
if the user does not respond to the medium-level alert, sending a high-level alert to the user by causing a human operator to telephone the user.

5. The method of claim 1, wherein after sending the alert, the method further comprises allowing the user to login to the third party server to obtain details about the one or more transactions that triggered the alert.

6. The method of claim 1, wherein receiving the records for the transactions involves:
obtaining account-access information from the user; and
using the account-access information to obtain the records for the transactions associated with the financial account from the financial institution.

7. The method of claim 1, wherein the method further comprises allowing the user to specify and/or modify the one or more rules that determine whether an alert should be triggered.

8. The method of claim 1, wherein the method further comprises using feedback about whether alerts are false positive alerts, true positive alerts, false negative alerts or true negative alerts, to update the one or more rules that determine whether an alert should be triggered.

9. The method of claim 1, wherein the method further comprises using an expert system (or neural network or other adaptive system) to adjust the one or more rules that determine whether an alert should be triggered based upon transaction history information associated with the user and/or similar users.

10. The method of claim 1, wherein receiving the records for the transactions involves receiving records for multiple financial accounts belonging to the user, wherein the multiple financial accounts are associated with multiple financial institutions.

11. The method of claim 1, wherein the financial account can include:
a bank account;
a credit-card account; and
a credit report for the user.

12. A computer-readable storage medium storing instructions that when executed by a computer cause the computer to perform a method for performing an activity watch operation on a financial account, the method comprising:
receiving records for transactions associated with the financial account;
wherein the records are received at a third-party server from a financial institution which maintains the financial account, wherein the third-party server is independent from the financial institution;
applying one or more rules to the records to determine whether an alert should be triggered; and
if a rule indicates that an alert should be triggered, sending the alert to a user who has an interest in the financial account.

13. The computer-readable storage medium of claim 12, wherein sending the alert to the user involves:
sending an email to the user;
sending a pager notification to the user;
sending a recorded telephone message to the user;
sending a facsimile to the user; or
causing a human operator to contact the user.

14. The computer-readable storage medium of claim 12, wherein sending the alert to the user involves sending an escalating series of alerts to the user if the user does not respond to any of the alerts.

15. The computer-readable storage medium of claim 12, wherein sending the escalating series of alerts involves:
sending a low-level alert in the form of an email message; and
if the user does not respond to the low-level alert, sending a medium-level alert in the form of a pager notification or a recorded telephone message to the user; and
if the user does not respond to the medium-level alert, sending a high-level alert to the user by causing a human operator to telephone the user.

16. The computer-readable storage medium of claim 12, wherein after sending the alert, the method further comprises allowing the user to login to the third party server to obtain details about the one or more transactions that triggered the alert.

17. The computer-readable storage medium of claim 12, wherein receiving the records for the transactions involves:
obtaining account-access information from the user; and
using the account-access information to obtain the records for the transactions associated with the financial account from the financial institution.

18. The computer-readable storage medium of claim 12, wherein the method further comprises allowing the user to specify and/or modify the one or more rules that determine whether an alert should be triggered.

19. The computer-readable storage medium of claim 12, wherein the method further comprises using feedback about whether alerts are false positive alerts, true positive alerts, false negative alerts or true negative alerts, to update the one or more rules that determine whether an alert should be triggered.

20. The computer-readable storage medium of claim 12, wherein the method further comprises using an expert system (or neural network or other adaptive system) to adjust the one or more rules that determine whether an alert should be triggered based upon transaction history information associated with the user and/or similar users.

21. The computer-readable storage medium of claim 12, wherein receiving the records for the transactions involves receiving records for multiple financial accounts belonging to the user, wherein the multiple financial accounts are associated with multiple financial institutions.

22. The computer-readable storage medium of claim 12, wherein the financial account can include:
a bank account;
a credit-card account; and
a credit report for the user.

23. An apparatus that performs an activity watch operation on a financial account, comprising:
an receiving mechanism configured to receive records for transactions associated with the financial account;
wherein the records are received at a third-party server from a financial institution which maintains the financial account, wherein the third-party server is independent from the financial institution; and
an alert-triggering mechanism configured to,
apply one or more rules to the records to determine whether an alert should be triggered, and
if a rule indicates that an alert should be triggered, to send the alert to a user who has an interest in the financial account.
